(19) United States
(12) Patent Application Publication
(10) Pub. No.: US 2017/0233541 A1
(43) Pub. Date: Aug. 17, 2017

(54) Method of Enhancing Adhesion of Silver Nanoparticle Inks on Plastic Substrates Using a Crosslinked Poly(vinyl butyral) Primer Layer

(71) Applicant: Tyco Electronics Corporation, Berwyn, PA (US)

(72) Inventors: Yiliang Wu, San Ramon, CA (US); Barry C. Mathews, Fremont, CA (US); Michael A. Oar, San Francisco, CA (US); Miguel A. Morales, Fremont, CA (US); Leonard Henry Radzilowski, Palo Alto, CA (US); James Paul Scholz, Mechanicsburg, PA (US); Bruce Foster Bishop, Aptos, CA (US); Jerry L. Moore, Mechanicsburg, PA (US)

(73) Assignee: Tyco Electronics Corporation, Berwyn, PA (US)

(21) Appl. No.: 15/043,460

(22) Filed: Feb. 12, 2016

(51) Int. Cl. C08J 7/04; C23C 4/129; B05D 1/00; B05D 1/30; B05D 1/02; B05D 1/18

(52) U.S. Cl. CPC C08J 7/045; B05D 1/02; B05D 1/18; B05D 1/005; B05D 1/30; C23C 4/129; C08J 2369/00; C08J 2429/14; C08J 2429/04

(57) ABSTRACT

A primer layer comprising a polyvinyl butyral resin enhances adhesion of silver nanoparticle inks onto plastic substrates. The primer layer comprises a polyvinyl butyral (PVB) resin having a polyvinyl alcohol content between about 18 wt. % to about 21 wt. %. The PVB resin may also have a glass transition temperature greater than about 70° C. Optionally, the PVB primer layer may further be enhanced by cross-linking using a melamine-formaldehyde resin. Conductive traces formed on plastic substrates having the PVB primer layer exhibit an acceptable cross-hatch adhesion rating with little to no degradation of adhesion being observed after exposure to 4-days salt mist aging or 1-day high humidity aging.

### FIELD

The present disclosure relates to silver nanoparticle ink compositions and the use thereof. More specifically, this disclosure relates to electronic components that include silver nanoparticle inks applied on to a plastic substrate and methods of enhancing adhesion thereto.

### BACKGROUND

The statements in this section merely provide background information related to the present disclosure and may not constitute prior art.

Conductive inks are increasingly being used to form printed elements, such as antennas or sensors, in a variety of 2-D and 3-D electronic applications. However, the adhesion of conductive inks to plastic substrate materials, such as low-cost polycarbonate, is relatively poor and can limit the useful life associated with the printed elements.

Generally, two types of conductive inks are being utilized, namely, polymer thick film (PTF) pastes and metal nanoparticle inks. The PTF pastes are often composed of micron-size metal flakes dispersed in polymeric binders. The use of polymeric binders allows the cured PTF pastes to adhere to various substrate materials. However, these polymeric binders also act as an insulator and have an adverse effect on the conductivity exhibited by the printed conductive elements.

In comparison, the metal nanoparticle inks generally include very little to no amount of polymeric binders. Thus upon sintering of the nanoparticle inks, a higher level of conductivity is often obtained. However, this increase in conductivity is obtained at the expense of adhesion to the substrate material.

The use of plastic substrate materials reduces the sintering temperature that can be utilized to cure the conductive inks. The use of low-cost, temperature sensitive plastic substrates requires the conductive ink to exhibit good adherence of the ink to the substrate along with retaining high conductivity (i.e., low resistivity) upon exposure to a low annealing or sintering temperature.

### SUMMARY

The present disclosure generally provides a method of forming a conductive trace on a substrate and the functional layered composite formed therefrom. The method comprises providing the substrate; applying a primer layer onto a surface of the substrate; at least partially curing the primer layer; applying a silver nanoparticle ink onto the primer layer; and annealing the silver nanoparticle ink to form the conductive trace, such that the conductive trace exhibits a 4B or higher level of adhesion, alternatively, a 5B level of adhesion. The primer layer contains a polyvinyl copolymer that comprises a plurality of polyvinyl butyral (PVB) segments, polyvinyl alcohol segments, and optionally polyvinyl acetate segments. The polyvinyl alcohol segments are present in an amount ranging from about 18 to about 21 wt. % based on the weight of the polyvinyl copolymer. When desirable, the conductive trace may exhibit a peel strength that is greater than about 1.5×10² N/m. The polyvinyl copolymer may also have a glass transition temperature that is greater than about 70° C.

The primer layer may be applied to the substrate using a spin coating, a dip coating, a spray coating, a printing, or a flow coating technique and the silver nanoparticle ink can be applied onto the at least partially cured primer layer using an analog or a digital printing method. When desirable, the method may further comprise treating the surface of the substrate using an atmospheric/air plasma, a flame, an atmospheric chemical plasma, a vacuum chemical plasma, UV, UV-ozone, heat treatment, solvent treatment, mechanical treatment or a corona discharge process prior to the application of the primer layer.

According to one aspect of the present disclosure, the primer layer is at least partially cured at a temperature that is no more than 120° C. for a period of time ranging between about 2 minutes to about 60 minutes. The at least partially cured primer layer may have an average thickness that is between about 50 nanometers to about 1 micrometer. The primer layer may optionally comprise a cross-linking agent in an amount that ranges between about 0.05 wt. % and about 10.0 wt. % of the weight of the primer layer. The cross-linking agent may comprise at least one of alkylated melamine-formaldehyde (MF) resins, phenolic resins, epoxy resins, di-aldehydes, or di-isocyanates.

According to another aspect of the present disclosure, the conductive trace may exhibit 5B adhesion after exposure for at least one day to a high humidity environment with 90% relative humidity at 60° C. Alternatively, the conductive trace exhibits 5B adhesion after exposure to 4 days of aging in a salt mist test.

The substrate is a plastic substrate that may be selected as one from the group of a polycarbonate, an acrylonitrile butadiene styrene (ABS), a polyamide, or a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) resin.

The silver nanoparticle ink comprises silver nanoparticles having an average particle diameter in the range of about 2 nanometers (nm) to about 800 nanometers; optionally, one or more of the silver nanoparticles is at least partially encompassed with a hydrophilic coating. The silver nanoparticles may be incompletely fused upon annealing.

According to another aspect of the present disclosure, a functional conductive layered composite may comprise the conductive trace formed according to the teachings described above and further defined herein. The functional conductive layered composite may function as an antenna, an electrode of an electronic device, or to interconnect two electronic components.

According to yet another aspect of the present disclosure, a method of forming a functional conductive layered composite comprises providing a plastic substrate; applying a primer layer to a surface of the plastic substrate; at least partially curing the primer layer at a temperature at or below 120° C.; applying a silver nanoparticle ink onto the primer layer; annealing the silver nanoparticle ink at a temperature at or below 120° C. to form the conductive trace, such that the conductive trace exhibits a 5B level of adhesion; and incorporating the conductive trace into the functional conductive layered composite. The conductive trace also may exhibit 5B adhesion after exposure for 10 days to a high humidity environment with 90% relative humidity at 60° C.

The plastic substrate in the layered composite may be a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) substrate. The primer layer comprises polyvinyl butyral, polyvinyl alcohol, and polyvinyl acetate polymer segments according to formula F-1, and an optional crosslinking agent, wherein subscripts x, y, and z represent the weight percentage of the segments, in the primer layer, such that x=77-82 wt. %; y=18-21 wt. %, and z=0-2 wt. %.

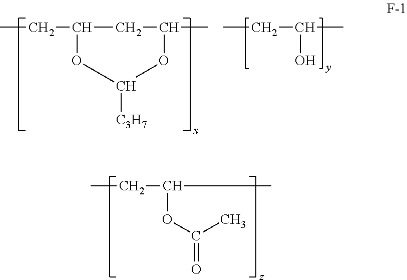

The at least partially cured primer layer has an average thickness that is between about 50 nanometers to about 1 micrometer.

The silver nanoparticle ink used in the layered composite comprises silver nanoparticles having an average particle diameter in the range of about 2 nanometers to about 800 nanometers. The silver nanoparticles may be incompletely fused after annealing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a printed silver ink antenna that has failed to adhere to a substrate after exposure to salt mist and temperature/humidity (i.e., damp heat) testing.

FIG. 2 is a schematic describing a method of enhancing adhesion according to the teachings of the present disclosure.

FIG. 3A is a scanning electron microscopy (SEM) image of the silver nanoparticles in a silver nanoparticle film applied onto a polycarbonate substrate prior to annealing.

FIG. 3B is a scanning electron microscopy (SEM) image of the silver nanoparticles in a silver nanoparticle film applied onto a polycarbonate substrate after annealing at 120° C.

FIG. 3C is a scanning electron microscopy (SEM) image of the silver nanoparticles in a silver nanoparticle film applied onto a polycarbonate substrate after annealing at 180° C.

FIG. 4A is a plan view of a cross-cut area after tape adhesion testing of a comparative annealed silver nanoparticle ink applied to a polycarbonate substrate cleaned with isopropanol.

FIG. 4B is a plan view of a cross-cut area after tape adhesion testing of a comparative annealed silver nanoparticle ink applied to a polycarbonate substrate cleaned with isopropanol and treated with air plasma.

FIG. 5A is a plan view of a cross-cut area after tape adhesion testing of an annealed silver nanoparticle ink applied on a PVB primer layer (Mowital™ B16H) after exposure to a salt mist test.

FIG. 5B is a plan view of a cross-cut area after tape adhesion testing of an annealed silver nanoparticle ink applied on a PVB primer layer (Butvar™ B98) after exposure to a salt mist test.

FIG. 6A is a plan view of a cross-cut area after tape adhesion testing of an annealed silver nanoparticle ink applied onto a plastic substrate having an MF resin cross-linked PVB primer layer after 10 days humidity aging.

FIG. 6B is a top down detailed view of a cross-cut area after tape adhesion testing of an annealed silver nanoparticle ink applied onto a plastic substrate having an MF resin cross-linked PVB primer layer after 4 days salt mist aging.

FIG. 7 is a plan view of an aerosol jet printed antenna of an annealed silver particle ink coated onto a polycarbonate substrate having a cross-linked PVB primer layer after 10 days humidity aging.

### DETAILED DESCRIPTION

The following description is merely exemplary in nature and is not intended to limit the present disclosure, application, or uses. For example, the primer layer made and used according to the teachings contained herein is described throughout the present disclosure in conjunction with polycarbonate substrates commonly utilized in consumer electronic applications in order to more fully illustrate enhanced adhesion of silver nanoparticle inks and the use thereof. The incorporation and use of such primer layers to enhance adhesion of silver nanoparticle inks on other plastic substrates for use in a variety of applications is contemplated to be within the scope of the present disclosure. It should be understood that throughout the description, corresponding reference numerals or letters indicate like or corresponding parts and features.

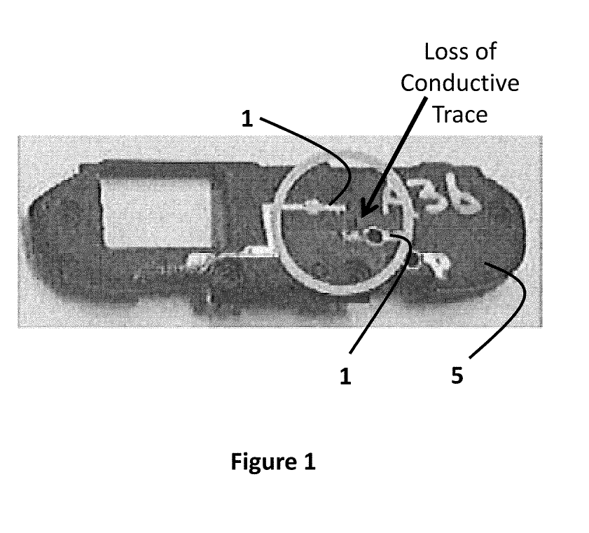

Printed silver nanoparticle inks show poor adhesion when applied to plastic substrates. As shown in FIG. 1, a portion of the printed conductive trace 1 formed from a silver nanoparticle ink is peeled off of a polycarbonate substrate 5 after temperature/humidity (Damp Heating) cycle or salt mist tests. Although conventional printed silver nanoparticle films have poor adhesion on polycarbonate substrates, adhesion of the films can be enhanced via substrate surface modification that involves the use of a primer layer as described by the method herein.

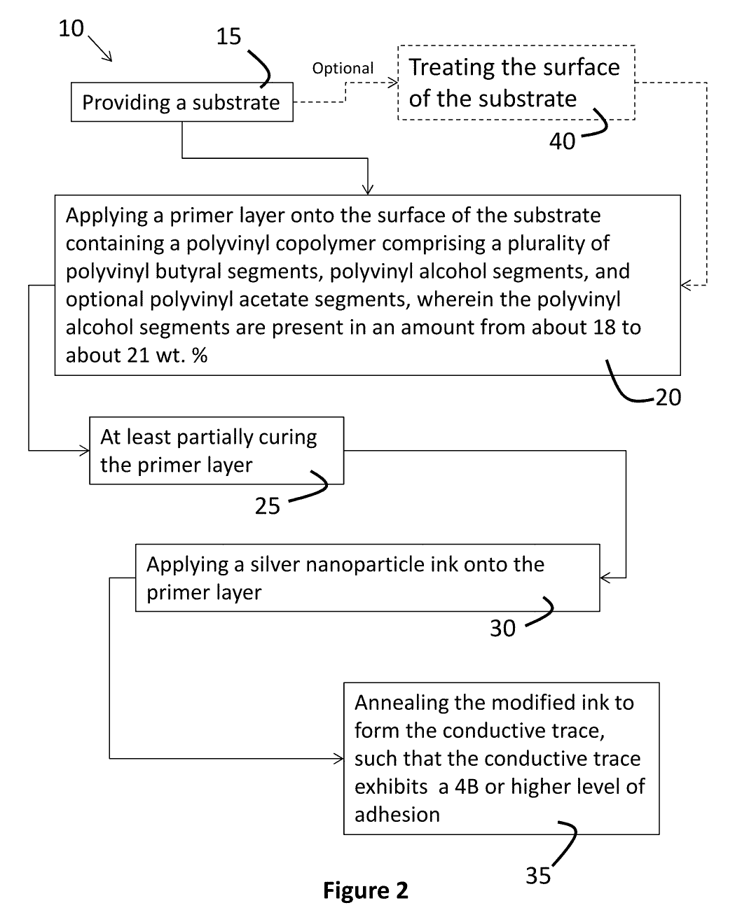

The present disclosure generally provides a method of forming a conductive trace on a substrate and the functional layered composite formed therefrom. Referring to FIG. 2, the method 10 comprises providing 15 the substrate; applying 20 a primer layer onto a surface of the substrate; at least partially curing 25 the primer layer; applying 30 a silver nanoparticle ink onto the primer layer; and annealing 35 the silver nanoparticle ink to form the conductive trace, such that the conductive trace exhibits a 4B or higher level of adhesion, alternatively, a 5B level of adhesion. The primer layer contains a polyvinyl copolymer that comprises a plurality of polyvinyl butyral (PVB) segments and polyvinyl alcohol segments, and optional polyvinyl acetate segments. The polyvinyl alcohol segments are present in an amount from about 18 to about 21 wt. % based on the weight of the polyvinyl copolymer. When desirable, the conductive trace may exhibit a peel strength that is greater than about 1.5×10² N/m, alternatively greater than 2.0×10² N/m, or alternatively greater than 2.5×10² N/cm, according to the FTM-2 90 degree peel test method (FINAT, Féderation INternationale des fabricants et transformateurs d'Adhésifs et Thermocollants sur papiers et autres). The polyvinyl copolymer may also have a glass transition temperature that is greater than about 70° C., alternatively greater than 75° C. For the purpose of this disclosure, the term “conductive trace” refers to any conductive elements in any suitable shapes such as a dot, a pad, a line, a layer, and the like.

The primer layer of the present disclosure generally provides for adhesion enhancement of silver nanoparticle inks on plastic substrates, such as polycarbonate, among others, at a low sintering temperature without any loss in the high conductivity of the annealed inks. The primer layer comprises, consists of, or consists essentially of a polyvinyl butyral (PVB) copolymer, optionally cross-linked with a melamine-formaldehyde (MF) resin. A PVB copolymer having polyvinyl alcohol content between about 18 wt. % to about 21 wt. % and a glass transition temperature that is greater than 70° C. can be used as a primer layer in order to enhance the adhesion of silver nanoparticle inks to various plastic substrates. Cross-linking the PVB copolymer with about 1.0 wt. % of a melamine-formaldehyde (MF) resin can further improve the adhesion strength of the annealed ink or conductive trace to the plastic substrate. Various electronic devices that incorporate a primer layer formed according to the teachings of the present disclosure exhibit excellent initial cross hatch adhesion at a 4B or higher level, alternatively at a 5B level with no degradation of adhesion occurring upon exposure to 4-day salt mist aging and/or exposure to a high humidity environment (90% relative humidity at 60° C.) for at least 1 day, alternatively, at least 4 days, alternatively, 10 days.

The PVB copolymer of the present disclosure can operate as an adhesive, providing strong binding to many surfaces. The PVB copolymer comprises three components of polyvinyl butyral, polyvinyl alcohol, and polyvinyl acetate. A general structure is shown in Formula F-1 below, wherein x, y, and z represent the weight percentage of the segments, in the primer layer, such that x=77-82 wt. %; y=18-21 wt. %, and z=0-2 wt. %.

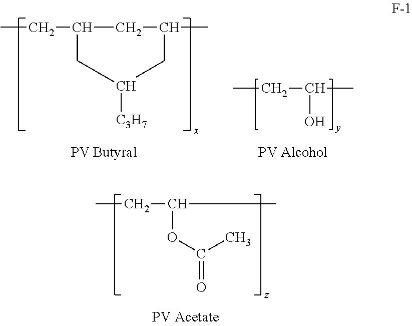

The silver nanoparticles have a particle size from about 2 nanometers (nm) to about 500 nm; alternatively, from about 50 nm to about 300 nm; alternatively, from about 10 nm to about 300 nm. When desirable, the silver nanoparticles may also have organic stabilizers attached to the surface, which prevent the aggregation of the silver nanoparticles and help dispersion of the nanoparticles in suitable solvents. According to one aspect of the present disclosure, the silver nanoparticles may have a hydrophilic coating on the surface. In this case, the silver nanoparticles are dispersible in polar solvents such as acetates, ketones, alcohols, or even water.

The mechanism through which a silver nanoparticle film adheres to a plastic substrate has been attributed to van der Waals forces between the particles and the substrate's surface. Referring once again to FIG. 2, based on this mechanism the adhesion may be improved by performing various physical treatments (40) of the surface of the substrate, including, but not limited to, an atmospheric/air plasma, a flame, an atmospheric chemical plasma, a vacuum chemical plasma, UV, UV-ozone, heat treatment, solvent treatment, mechanical treatment, such as roughening the surface with sand paper, abrasive blasting, water jet, and the like, or a corona discharging process prior to the application of the primer layer.

According to another aspect of the present disclosure, the silver nanoparticles may be fused together upon annealing at the desired temperature. Alternatively, the silver nanoparticles can be not properly sintered together, especially at the interface region, at the predetermined annealing temperature, which is determined according to the properties of the substrate or other layers that are pre-deposited on to the substrate. According to some aspects of the present disclosure, a majority of the silver nanoparticles are not fused together upon annealing. Specifically, the average particle size of the silver nanoparticles in the conductive trace after annealing is substantially the same as that in the silver nanoparticle ink. According to other aspects of the present disclosure, a minority of the silver nanoparticles are not fused together upon annealing. In specific embodiments, at least 5 wt %, alternatively at least 10 wt %, or alternatively at least 40 wt % silver nanoparticles are not fused together. The weight percentage can be measured by extracting the annealed silver nanoparticle conductive layer with a solvent that is compatible with the nanoparticles and calculating the weight loss.

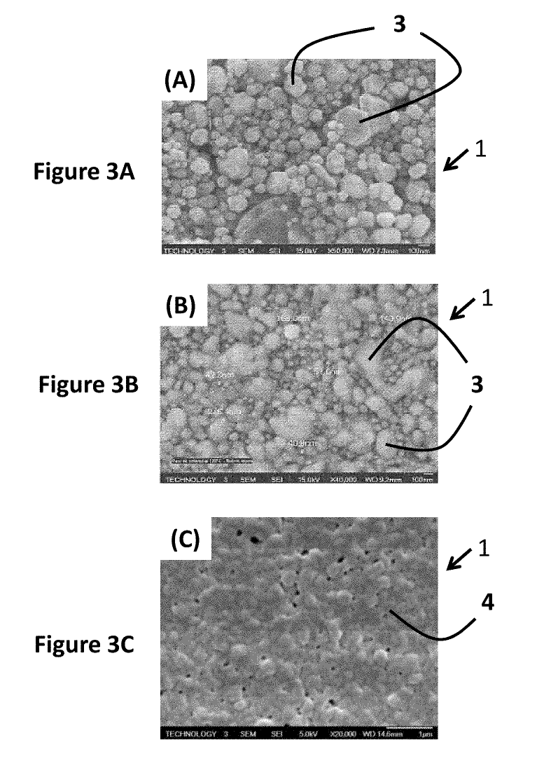

Referring now to FIGS. 3A and 3B, optical images of silver nanoparticle films 1 before and after annealing at 120° C. for 60 min, respectively, are provided as obtained by scanning electron microscopy (SEM). In FIG. 3C an SEM image of a silver nanoparticle film 1 annealed at 180° C., which is above the desired limit for many plastic substrates. Each of the films 1, which have a thickness of about 5-8 μm, are coated on a polycarbonate substrate using a doctor blade having a 0.0508 mm (2-mil) gap. The silver nanoparticles 3 in the silver nanoparticle film 1 range in size between about 40 nm to about 300 nm before annealing (see FIG. 3A). In FIG. 3C, the particles are shown to fuse together 4 when annealed at a temperature of 180° C. However, the predetermined temperature to reduce or eliminate degradation and/or deformation of the polycarbonate substrate is 120° C. After annealing at 120° C. (see FIG. 3B), a large amount silver nanoparticles 3 having distinct boundaries demonstrating a particle size between about 40 nm to about 300 nm still exist at the interface region. Thus after annealing at 120° C., the silver nanoparticles 3 in the film 1 are not properly sintered by exposure to such a low sintering or annealing temperature, which is referred as an incompletely fused silver nanoparticle conductive layer.

Without wanting to be limited to theory, it is believed that the polyvinyl copolymer primer layer bonds to the surface of the silver nanoparticles, thereby, providing good adhesion. This bonding is particularly useful for silver nanoparticles that are not fused together properly due to the low annealing temperature predetermined by the substrate material. The presence of the PVB primer layer changes the dispersive adhesion, which is mainly attributed to van der Waals forces based on particle adhesion mechanisms, into chemical bonding.

The optional cross-linker can be present in the primer layer from about 0.5 to about 10 wt. %; alternatively, from about 0.5 to about 5 wt. %, alternatively, from about 1 to about 3 wt. % based on the overall weight of the primer layer. The optional cross-linker may be, without limitation, an alkylated melamine-formaldehyde resin. Several examples of other cross-linkers that may be used include phenolic resins, epoxy resins, dialdehydes, di-isocyanates, and the like.

The primer layer can be applied to the substrate's surface using any suitable method known to one skilled in the art, including, but not limited to spin coating, dip coating, spray coating, printing, and the like, followed by curing at a temperature that is between about 60° C. to about 150° C., alternatively, from about 80° C. to about 120° C., or alternatively, from about 100° C. to about 120° C., for a time period ranging between about 2 minutes to about 60 minutes, alternatively, from about 5 minutes to about 10 minutes. The thickness of the primer layer can be between about 50 nm to about 1 micrometer or micron, alternatively, from about 100 nm to about 500 nm, alternatively, from about 100 nm to about 300 nm. When desirable, the primer layer may also function as a planarization layer.

The silver nanoparticle ink can be applied onto the at least partially cured primer layer using an analog or a digital printing method. The ability to apply the silver nanoparticle ink to a plastic substrate using an additive printing technique offers several advantages, such as fast turn-around time and quick prototyping capability, easy modification of device designs, and potentially lower-manufacturing costs due to reducing material usage and the number of manufacturing steps. The direct printing of conductive inks also enables the use of thinner substrates when forming light-weight devices. Additive printing may also be a more environmentally friendly approach due to the reduced chemical waste generated in the device manufacturing process, when compared to conventional electroplating or electroless plating processes.

In general, printing technologies can be divided into two major categories, namely, analog printing and digital printing. Several examples of analog printing include, without limitation, flexographic, gravure, and screen printing. Several examples of digital printing include, but are not limited to, inkjet, aerosol jet, disperse jet, and drop-on-demand techniques. While analog printing offers high printing speed, digital printing enables the facile change of printed pattern designs, which may find use in the field of personalized electronics. Among the digital printing technologies, aerosol jet and disperse jet are attractive due to their large distance between the nozzle and the substrate surface. This characteristic allows conformal deposition of conductive inks on substrates that exhibit a topographic structure. When integrated with a 5-axis motion-control stage or robotic arm, aerosol jet and dispense jet can be used to print conductive elements onto 3-D surfaces. The silver nanoparticle ink may have a viscosity that is predetermined by the application process, for example from a few centipoise (cps) or millipascal-seconds (mPa-sec) to about 20 mPa-sec for an inkjet printing process, or from about 50 mPa-sec to about 1000 mPa-sec for aerosol jet, flexographic, or gravure printing processes, or above 10,000 mPa-sec for a screen printing process. Alternatively, the silver nanoparticle conductive trace can be printed onto 3-D surfaces using aerosol jet and/or dispense jet printing techniques.

The plastic substrate may be selected from a group consisting of a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, a polyvinylidene fluoride (PVDF), and a copolymer thereof. A specific example of a polyether imide and a polycarbonate substrate is Ultem™ (SABIC Innovative Plastics, Massachusetts) and Lexan™ (SABIC Innovative Plastics, Massachusetts), respectively. Alternatively, the substrate is a polycarbonate substrate.

After applying the silver nanoparticle ink onto the primer layer, the silver nanoparticle ink is annealed at a temperature that has no adverse effect on the substrate or the pre-deposited layer. According to one aspect of the present disclosure, the silver nanoparticle ink is annealed at a temperature no more than 150° C., alternatively, no more than 120° C., or alternatively, no more than 80° C. After annealing, resistivity of the annealed silver nanoparticle conductive trace can be measured using a 4-point probe method according to ASTM-F1529. According to another aspect of the present disclosure, the conductive trace has a resistivity less than 1.0×10⁻⁴ ohms-cm; alternatively less than 5.0×10⁻⁵ ohms-cm; or alternatively less than 1.0×10⁻⁵ ohms-cm. The ability to achieve low resistivity and good adhesion upon annealing at a low temperature is desirable for many applications. The thickness of the annealed silver nanoparticle conductive trace can be for example from about 100 nm to about 50 microns, alternatively, from about 100 nm to about 20 microns, or alternatively, from about 1 micron to about 10 microns, depending on the methods used to apply the ink and the applications in which the conductive trace is utilized.

Another aspect of the present disclosure is a functional conductive layered composite comprising the conductive trace formed according to the teachings described above and further defined herein. For the purpose of this disclosure, the term “functional conductive layered composite” refers to any component, part, or composite structure that incorporates the conductive trace. In embodiments, the functional conductive layered composite may function as an antenna, an electrode of an electronic device, or to interconnect two electronic components.

The following specific examples are given to further illustrate the preparation and testing of conductive tracings according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure.

Commercially available silver nanoparticle inks are used without modification. The specific silver nanoparticle ink used in the examples is PG-007 (Paru Co. Ltd., South Korea). This silver nanoparticle ink comprises about 60 wt. % silver dispersed in mixed solvents of 1-methoxy-2-propanol (MOP) and ethylene glycol (EG). The silver nanoparticles have a particle size that is within the range of about 50 nm to about 300 nm with an overall average size between about 80-100 nm. The substrate in the examples is a Lexan 141R polycarbonate substrate (SABIC Innovative Plastics, Massachusetts).

The adhesion of the annealed or sintered films that are formed from the silver nanoparticle inks applied to a plastic substrate is tested according to ASTM D3359-09 (ASTM International, West Conshohocken, Pa.). The silver films are crosscut into 100 pieces of 1×1 mm squares. Then, Scotch™ tape 600 (The 3M Company, St. Paul, Minn.) is applied on top of the crosscut area, and gently rubbed to make a good contact between the tape and the silver nanoparticle films. After 1.5 minutes, the tape is peeled off back-to-back to examine how much silver film is removed from the substrate. Based on the amount of silver film that is removed, the adhesion is rated from 0B to 5B with 0B being the worst and 5B the best.

### Example 1—Controls

Polycarbonate substrates were cleaned with isopropanol (IPA) and dried with compressed air. Some of the substrates were further treated with air plasma to improve the adhesion. The silver nanoparticle ink PG-007 (Paru Co. Ltd, South Korea) was applied on top of the substrate with a PA5363 applicator (BYK Gardner GmbH, Germany) having a 0.0508 mm (2-mil) gap. The wet films were dried at room temperature for about 10 minutes, then completely dried and annealed in a thermal oven at 120° C. for 60 minutes. It should be noted that this low annealing temperature of 120° C. is determined by the properties exhibited by the low-cost and temperature-sensitive polycarbonate substrate.

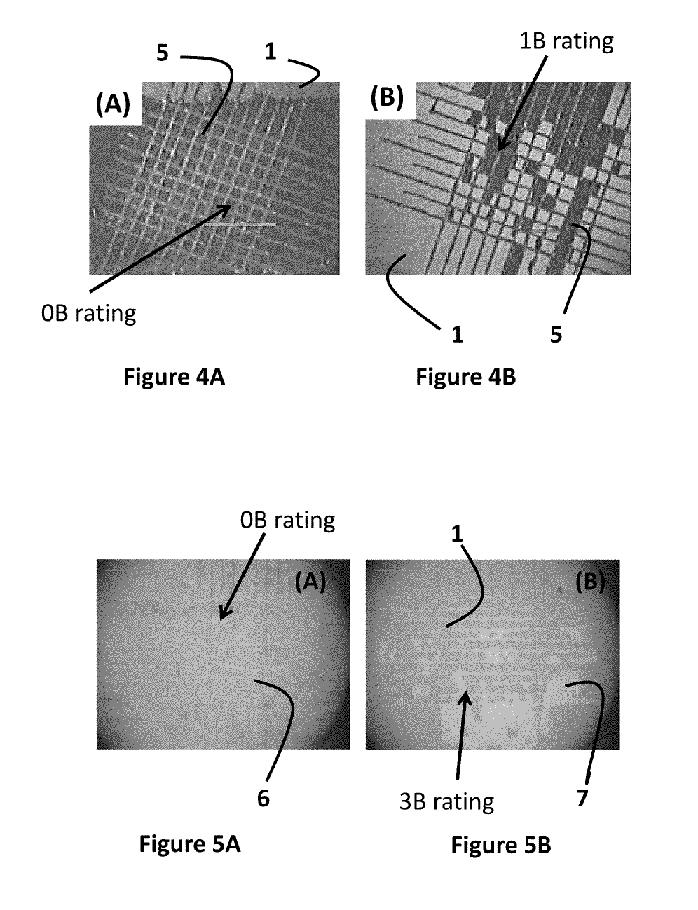

FIG. 4A shows the result of the adhesion test for the annealed, comparative or control PG-007 ink 1 on a plain polycarbonate substrate 5. The crosscut area was completely removed by the tape (0B rating), indicating very poor adhesion of the silver nanoparticle ink film 1 to the polycarbonate substrate 5 upon annealing at 120° C. Air plasma treatment improved adhesion slightly to about a 1B level (see FIG. 4B), but not anywhere near the desired 5B rating. The annealed silver nanoparticle films 1 were freshly prepared and were not subjected to any harsh environment tests such as high humidity or salt mist. These harsh environment tests will usually cause further degradation of adhesion.

Within this specification, various embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### Example 2—Samples with PVB Primer Layer

Depending on the desired molecular weight and polyvinyl alcohol content, PVB resins have many different grades. The PVB resin was first dissolved in ethanol or butanol solvent to form a solution at 2.0 wt. % concentration based on the overall weight of the solution. The solution was spin coated on an air-plasma treated polycarbonate substrate at 1000 rpm for 60 seconds to yield a primer layer having a thickness between 130-160 nm as measured using a surface profilometer. After the PVB film was dried at 120° C. for 10 minutes, the silver nanoparticle ink (PG-007, Pam Co. Ltd, South Korea) was coated on top of the primer layer in the same way as discussed for the Controls in Example 1. After annealing the silver nanoparticle films at 120° C. for 60 minutes, the adhesion of the silver nanoparticle films was assessed according to ASTM D3359-09. The films were further subjected to a high humidity environment having 90% relative humidity (RH) at 60° C. for a period ranging between 1 to 10 days. The adhesion of the silver nanoparticle films was then reevaluated.

The adhesion results obtained for different types of PVB primer layers before and after humidity aging are summarized in Table 1. Two major different properties of the PVB resins are the amount of polyvinyl alcohol present and the glass transition temperature. In general, the PVB primer layer improved adhesion of the silver nanoparticle film. All of the freshly annealed film samples exhibited adhesion rated between the 2B to 5B level. The PVB resin with the highest polyvinyl alcohol content (Mowital™ B30T, Kuraray America, Inc., Houston, Tex.) is the least effective primer material towards enhancing the adhesion.

After aging the samples in a high humidity chamber for 1 day, the PVB resin with the lowest polyvinyl alcohol content (Butvar™ B79, Eastman Chemical Co., Kingsport, Tenn.) failed adhesion test as well. Upon aging the samples for 10 days, the sample with Mowital™ B16H (Kuraray America Inc., Houston, Tex.) as the primer layer exhibited a large variation in adhesion results during the adhesion test. More specifically, some area of the silver nanoparticle film remained intact while other areas of the film were removed completely. On the other hand, the sample with Butvar™ B98 (Eastman Chemical Co., Kingsport, Tenn.) as the primer layer showed good adhesion of 5B for the entire film. Although not wanting to be limited to a specific theory, the better adhesion of the silver nanoparticle films with a Butvar™ B98 primer layer is believed to be due to its high glass transition temperature.

TABLE 1

| | | | Adhesion Rating | | |
|---|---|---|---|---|---|
| | PV Alcohol | | | 1 day | 10 days |
| PVB Description | Content (wt. %) | T_{g} (° C.) | Fresh | aging | aging |
| Mowital ™ B16H | 18-21 | 63 | 5B | 5B | 0-5B |
| Mowital ™ B30T | 24-27 | 68 | 2B | 0B | X |
| Butvar ™ B79 | 11-13.5 | 62-72 | 5B | 0B | X |
| Butvar ™ B98 | 18-20 | 72-78 | 5B | 5B | 5B |

The samples with Mowital™ B16H and Butvar™ B98 as the primer layer were further tested in a salt mist chamber for 96 hours. The operating parameters for this aging cycle include a chamber temperature of 35° C., an aeration tower temperature of 48° C., a 5% brine solution purity of sodium chloride with no more than 0.3% impurities at 95% relative humidity (RH), an aeration tower pressure of 1.52×10⁵ Pascals (22 PSI), a brine solution pH range from about 6.5 to 7.2, a specific gravity range from 1.031 to 1.037, and a collection rate of 0.5 to 3 ml per hour. After exposure to this salt mist aging, the sample with the Mowital™ 16H primer layer 6 completely failed adhesion test (see FIG. 5A) with an adhesion rating of 0B. The sample with the Butvar™ B98 primer layer on the plastic substrate 7 showed only partial failure (see FIG. 4B) with an adhesion rating of 3B. The data indicates that the Butvar™ B98 primer layer can enhance adhesion of the silver nanoparticle ink on a polycarbonate substrate even after exposure to a salt mist chamber for 96 hours.

Since the Butvar™ B98 PVB resin has a similar PV alcohol content as Mowital™ B16H PVB resin, the enhanced adhesion of the annealed silver nanoparticle film to polycarbonate in the presence of a Butvar™ B98 primer layer is believed to be due to its high glass transition temperature. Generally speaking, the Butvar™ B98 primer layer is much less sensitive to the high humidity conditions, as a result, enhanced adhesion for the silver nanoparticle conductive layer is observed under such harsh conditions.

The addition of a PVB resin directly into a commercially available silver nanoparticle ink composition is observed to further enhance initial adhesion, but has little to no effect on adhesion after exposure to a high humidity environment. A total of 0.5 wt. % of a PVB resin was incorporated into a commercially available silver nanoparticle ink composition based on the overall weight of the silver nanoparticle ink composition. The addition of the PVB resin to the ink composition was found to have no effect on the viscosity or color as the silver nanoparticle ink. However, when a higher amount of PVB was added (e.g. about 1 to about 3 wt. %), aggregation of the silver nanoparticles was observed. The silver nanoparticle ink with 0.5 wt. % PVB resin added to the composition applied to a polycarbonate substrate having a PVB resin primer layer and annealed at 120° C. was found to further enhance initial adhesion of the silver nanoparticle films in fresh samples. However, upon aging these fresh samples in a high humidity environment for 24 hours, the adhesion was observed to be similar to the adhesion of samples that include a commercially available silver nanoparticle ink without any PVB resin added to the composition that has been applied to and annealed on a PVB modified plastic substrate.

### Example 3—Samples with Cross-Linked PVB Primer Layer

In this example, Butvar™ B98 PVB resin was used as the primer layer. To further improve the stability of the PVB primer layer under harsh environments, a small amount of a melamine-formaldehyde (MF) resin cross-linker was added. The chemical structure of this specific cross-linker is shown below as F-2. The hydroxyl groups in the PVB resin will react with the methylated formaldehyde group to form a cross-linked network. Upon crosslinking, the primer layer becomes less sensitive to moisture.

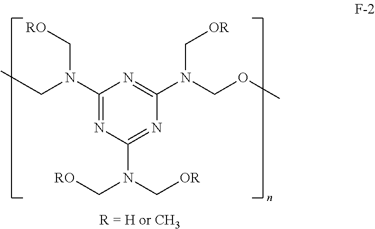

A total of 1 gram of a PVB resin (Butvar™ B98) was dissolved in 49 grams of n-butanol. Then 50 milligrams of a poly(melamine-co-formaldehyde) (MF-resin) was added to the solution as the cross-linker. The amount of cross-linker was calculated to be 5 wt. % based on the total polyvinyl alcohol content in the PVB resin. The solution was spin coated onto an air-plasma treated polycarbonate substrate at 1000 rpm for 60 seconds. After curing the cross-linker containing PVB resin film at 120° C. for 10 minutes, the silver nanoparticle ink was coated on top of the primer layer and annealed in the same way as shown in the Controls of Example 1.

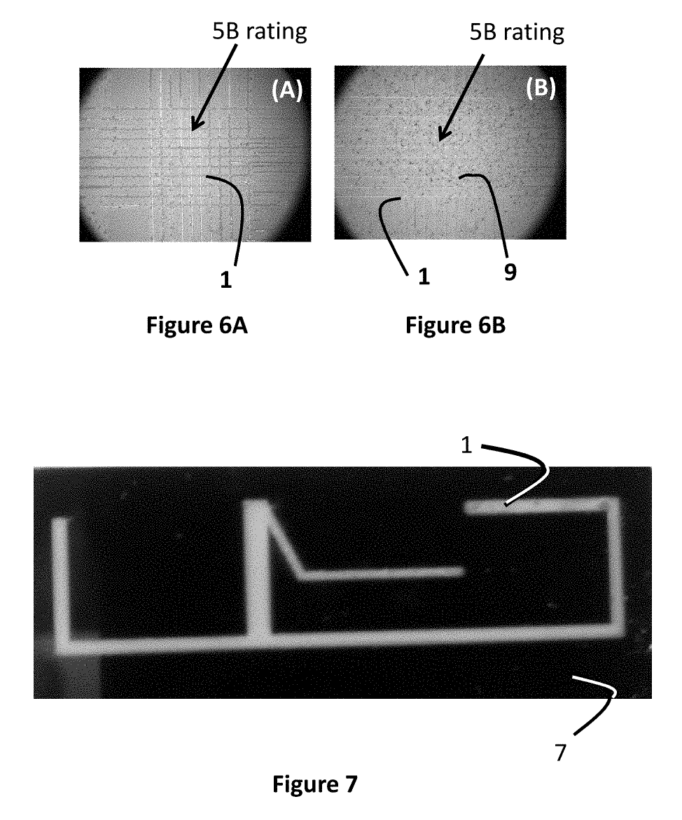

The annealed silver nanoparticle ink films showed excellent initial adhesion of 5B to the underlying plastic substrate. The samples were then placed in a high humidity chamber and salt mist chamber for accelerated aging testing. After aging, the adhesion of each silver nanoparticle film was reevaluated. As shown in FIG. 6A, no silver film 1 was peeled off from the polycarbonate substrate after exposure to the harsh humidity aging test after a period of 10 days. Similarly, as shown in FIG. 6B, no silver nanoparticle film 1 was peeled off from the polycarbonate substrate after exposure to the harsh salt misting aging after a period of four days (96 hours). The 5B adhesion ratings in both tests indicate excellent adhesion of the annealed silver nanoparticle films 1 to the MF-resin cross-linked PVB primer layer on the polycarbonate substrate. The black dots 9 in FIG. 6B are stains of salt or corrosion of the silver film 1 caused by salt crystals during the environmental test.

### Example 4—Conductive Traces Formed from Silver Nanoparticle Inks

A conductive trace 1 in the form of an antenna was printed with a commercially available silver nanoparticle ink annealed at 120° C. on a polycarbonate substrate modified with a cross-linked PVB primer layer 7. As shown in FIG. 7, no adhesion failure after 10 days aging in the high humidity chamber was observed. More specifically, the adhesion rating of 5B was obtained for the silver nanoparticle film 1 formed on a plastic substrate that includes a PVB primer layer 7.

The adhesion of silver nanoparticle films to plastic substrates is significantly enhanced with the use of a PVB resin as a primer layer. Further enhancement of adhesion is achieved upon cross-linking of the PVB layer with melamine-formaldehyde resin. No degradation of adhesion is observed after exposure to high humidity and salt mist aging.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of forming a conductive trace on a substrate, the method comprising:
providing the substrate;
applying a primer layer onto a surface of the substrate; the primer layer containing a polyvinyl copolymer comprising a plurality of polyvinyl butyral segments and polyvinyl alcohol segments, and optional polyvinyl acetate segments, wherein the polyvinyl alcohol segments being present in an amount from about 18 to about 21 wt. % based on the weight of the polyvinyl copolymer;
at least partially curing the primer layer;
applying a silver nanoparticle ink onto the primer layer; and
annealing the silver nanoparticle ink to form the conductive trace;
wherein the conductive trace exhibits a 4B or higher level of adhesion.

2. The method according to claim 1, where in the conductive trace exhibits a 5B level of adhesion.

3. The method according to claim 1, wherein the conductive trace exhibits a peel strength greater than 1.5×10² N/m.

4. The method according to claim 1, wherein the primer layer is applied to the substrate using a spin coating, a dip coating, a spray coating, a printing, or a flow coating technique and the silver nanoparticle ink is applied onto the at least partially cured primer layer using an analog or a digital printing method.

5. The method according to claim 1, wherein the primer layer is at least partially cured at a temperature no more than 120° C. for a period of time ranging between about 2 minutes to about 60 minutes.

6. The method according to claim 1, wherein the primer layer further comprises a cross-linking agent in an amount that ranges between about 0.05 wt. % to about 10 wt. % of the weight of the primer layer.

7. The method according to claim 1, wherein the at least partially cured primer layer has an average thickness that is between about 50 nanometers to about 1 micrometer.

8. The method according to claim 1, wherein the polyvinyl copolymer has a glass transition temperature that is greater than about 70° C.

9. The method according to claim 1, wherein the method further comprises treating the surface of the substrate using an atmospheric/air plasma, a flame, an atmospheric chemical plasma, a vacuum chemical plasma, UV, UV-ozone, heat treatment, solvent treatment, mechanical treatment or a corona discharge process prior to the application of the primer layer.

10. The method according to claim 1, wherein the conductive trace exhibits 5B adhesion after exposure for at least one day to a high humidity environment with 90% relative humidity at 60° C.

11. The method according to claim 1, wherein the conductive trace exhibits 5B adhesion after exposure to 4 days of aging in a salt mist test.

12. The method according to claim 1, wherein the substrate is a plastic substrate selected from the group consisting of a polycarbonate, an acrylonitrile butadiene styrene (ABS), a polyamide, or a polyester, a polyimide, vinyl polymer, polystyrene, polyether ether ketone (PEEK), polyurethane, epoxy-based polymer, polyethylene ether, polyether imide (PEI), polyolefin, a polyvinylidene fluoride (PVDF), or a copolymer thereof.

13. The method according to claim 1, wherein the silver nanoparticle ink comprises silver nanoparticles having an average particle diameter in the range of about 2 nanometers to about 800 nanometers; optionally, one or more of the silver nanoparticles is at least partially encompassed with a hydrophilic coating.

14. The method according to claim 6, wherein the cross-linking agent comprises at least one of alkylated melamine-formaldehyde resins, phenolic resins, epoxy resins, dialdehydes, or di-isocyanates.

15. The method according to claim 1, wherein the silver nanoparticles are incompletely fused upon annealing.

16. A functional conductive layered composite comprising the conductive trace formed according to the method of claim 1.

17. The functional conductive layered composite according to claim 16, wherein the functional conductive layered composite functions as an antenna, an electrode of an electronic device, or to interconnect two electronic components.

18. A method of forming a functional conductive layered composite comprising:
providing a plastic substrate selected from the group consisting of a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) substrate;
applying a primer layer to a surface of the plastic substrate; the primer layer comprising polyvinyl butyral, polyvinyl alcohol, and polyvinyl acetate polymer segments according to formula F-1, and an optional crosslinking agent, wherein subscripts x, y, and z represent the weight percentage of the segments, in the primer layer, such that x=77-82 wt. %; y=18-21 wt. %, and z=0-2 wt. %; 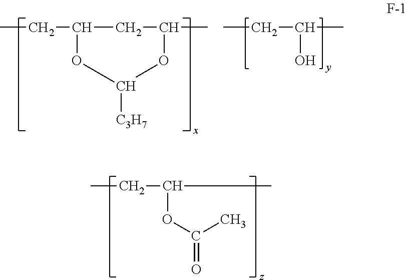
at least partially curing the primer layer at a temperature at or below 120° C.; wherein the at least partially cured primer layer has an average thickness that is between about 50 nanometers to about 1 micrometer;
applying a silver nanoparticle ink onto the primer layer, the silver nanoparticle ink comprising silver nanoparticles having an average particle diameter in the range of about 2 nanometers to about 800 nanometers;
annealing the silver nanoparticle ink at a temperature at or below 120° C. to form the conductive trace; wherein the conductive trace exhibits a 5B level of adhesion; and
incorporating the conductive trace into the functional conductive layered composite.

19. The method according to claim 18, wherein the conductive trace exhibits 5B adhesion after exposure for 10 days to a high humidity environment with 90% relative humidity at 60° C.

20. The method of claim 18, wherein the silver nanoparticles are incompletely fused after annealing.
